(19) United States
(12) Patent Application Publication
(10) Pub. No.: US 2010/0304690 A1
(43) Pub. Date: Dec. 2, 2010

(54) METHOD OF PASSIVELY DETECTING AN APPROACH TO A VEHICLE

(75) Inventors: DAVID T. PROEFKE, MADISON HEIGHTS, MI (US); WILLIAM A. BIONDO, BEVERLY HILLS, MI (US); CLARK E. MCCALL, ANN ARBOR, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/474,637

(22) Filed: May 29, 2009

(51) Int. Cl. G05B 19/00; H04B 1/00

(52) U.S. Cl. 455/69; 340/5.2

(57) ABSTRACT

A method for activating vehicle features when approaching a vehicle includes receiving (302) a message by a vehicle system (102) from a key fob (202), determining (312) if the key fob (202) is approaching the vehicle, activating (314) selected vehicle features if approaching the vehicle, and instructing (328) the key fob (202), if not approaching the vehicle, to reduce power until the message is no longer received by the vehicle system (102).

### TECHNICAL FIELD

The present invention generally relates to a system for sensing a user's approach to a vehicle and more particularly relates to activating vehicle features prior to the user's arrival at the vehicle.

### BACKGROUND OF THE INVENTION

Key fobs, or remote keyless entry devices, that unlock, for example, the driver's door, passenger doors, or the trunk lid are well known. Some key fobs control other user preferred features such as seat position, radio station, and air control temperature settings. Many key fobs are manually activated by the user (active approach) as the vehicle is approached. Other key fobs transmit a signal in response to a low frequency query from the vehicle (passive approach), with the key fob signal being detected by the vehicle for activating the desired features.

However, these known low frequency passive systems require continuous (periodic) transmission and typically have a limited range of less than two meters. However, the low frequency transmission must be sufficiently long to reduce the current consumption of the transmission, while being short enough to allow a noticeable approach to activate the feature before the user arrives at the vehicle. These low frequency systems provide less time than desired for the activation of, for example, approach lighting. The user is already at or very near the vehicle when approach lighting would activate.

Furthermore, these low frequency passive systems cause unintentional actuations when the user is near the vehicle but does not desire to activate the functions. These unintentional activations cause an undesired drain on the vehicle and fob batteries and may create a security issue if the unintentional actuation leaves the vehicle accessible. These low frequency passive systems may include provisions to deactivate the approach sensing after extended continuous activation; however, this has the undesired result of not providing the vehicle user the expected operation when they return to the vehicle.

Accordingly, it is desirable to provide a system that triggers passive approach features with greater range and low power consumption, while minimizing false approach notification. Furthermore, other desirable features and characteristics of the present invention will become apparent from the subsequent detailed description of the invention and the appended claims, taken in conjunction with the accompanying drawings and the foregoing technical field and background.

### SUMMARY OF THE INVENTION

A method for activating vehicle features when approaching a vehicle includes receiving a message by a vehicle system from a key fob, determining if the key fob is approaching the vehicle, activating selected vehicle features if approaching the vehicle, and instructing the key fob, if not approaching the vehicle, to reduce power until the message is no longer received by the vehicle system.

### DESCRIPTION OF THE DRAWINGS

The present invention will hereinafter be described in conjunction with the following drawing figures, wherein like numerals denote like elements, and

FIG. 1 is a block diagram of a vehicle system for implementing the exemplary embodiment;

FIG. 2 is a block diagram of a key fob for implementing the exemplary embodiment;

FIG. 3 is a flow chart of a method in accordance with an exemplary embodiment for use in the vehicle system of FIG. 1; and

FIG. 4 is a flow chart of a method in accordance with an exemplary embodiment for use in the key fob of FIG. 2.

### DETAILED DESCRIPTION OF THE INVENTION

The following detailed description of the invention is merely exemplary in nature and is not intended to limit the invention or the application and uses of the invention. Furthermore, there is no intention to be bound by any expressed or implied theory presented in the preceding technical field, background, brief summary or the following detailed description.

The method disclosed herein provides for the activation of features of a vehicle, for example approach lighting of an automobile, as the user approaches the vehicle from a distance sufficient to light the approach. A key fob periodically transmits an RF presence signal at a rate which allows for two or more detection periods during a normal approach to the vehicle. The transmit rate is determined with consideration of an approach speed, for example fast walking, and a minimum range, for example 200 meters. For each signal received, the vehicle system measures the relative signal strength and determines if the key fob is approaching the vehicle and if the signal strength is sufficient to indicate close proximity. Upon detection of close proximity, the vehicle actuates welcome features such as approach lighting and additional sensors. Close proximity, for example, could be 100 feet. However, when the vehicle is parked and the key fob stays in proximity to the vehicle, false actuations are avoided. The key fob will initially continue to periodically transmit a presence signal at the pre-established rate. If the vehicle system detects the continued presence of the key fob at a signal strength indicative of close proximity, the vehicle instructs the key fob to decrease power in increments until the key fob is no longer detected. Additionally, the key fob may halt transmissions upon extended periods without motion; transmissions would resume upon detection of new motion. Upon subsequent movement of the key fob closer to the vehicle, the vehicle system will receive the periodic signal from the key fob, activate the approach features, and instruct the key fob to assume normal power levels until a user initiated interaction, such as opening a door. For example, the vehicle may instruct the key fob to halt transmissions upon the opening of a vehicle door or ignition, which signals a drive cycle is in process.

More particularly, the method determines whether a periodically transmitted RF message from a key fob is valid and either increases or decreases the RF message signal strength depending on the validity. If a valid RF message signal exceeds a defined strength, the vehicle features are activated, a message counter is set to zero, and the key fob is instructed to increase transmitting power to its predetermined maximum level. When the vehicle receives a predetermined number of RF messages above a defined signal strength, the fob is instructed to transmit at a lower power level. This step is repeated until the key fob transmits at a power level low enough that the vehicle no longer receives the RF messages, thereby saving energy by allowing the vehicle to maintain a low-power, sleep state.

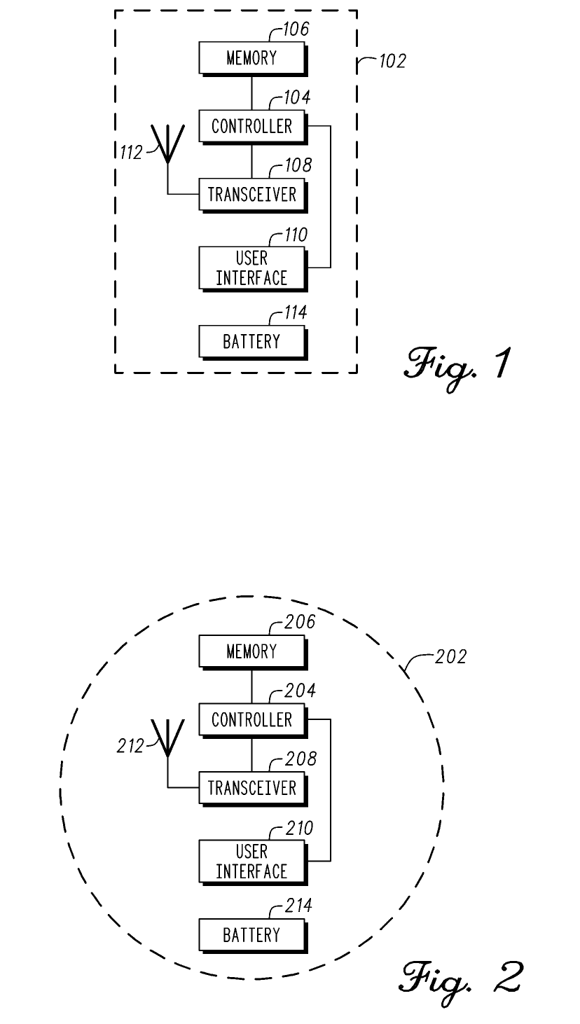

Referring to FIG. 1, a vehicle system 102 includes a controller 104 coupled to each of a memory 106, a transceiver 108, and a user interface 110. The vehicle may be any transportation device, but is an automobile in the exemplary embodiment discussed herein. The controller 104 preferably is a microprocessor, but may be other types of circuitry such as application specific integrated circuits or discrete logic. The memory 106 is any memory capable of storing information, but preferably is ROM, Flash, or RAM and may be or not be combined with the controller 104. The transceiver 108, and an antenna 112 coupled thereto, are capable of transmitting and receiving in any one of numerous RF ranges. The range of 900 MHz to 920 MHz is preferred for the exemplary embodiment. The antenna 112 preferably is positioned within the vehicle, but may be positioned on the outside of the vehicle. The user interface 110 may be a device in which the user provides information to the controller 104, but also may be settings registered by sensors disposed in various vehicle devices, for example, the position of the driver's seat or the mirrors, and a preferred radio station. Some features, such as approach lighting, may be automatically selected and need not be input by the user to the user interface 110. For example, when activated, the approach lighting may include one or more of interior lighting, door handle lights, fog lights, mirror mounted puddle lights, and reverse (back up) lights. A battery 114, which may be the vehicle's main battery, is provided to supply power to each of the controller 104, memory 106, transceiver 108, and user interface 110.

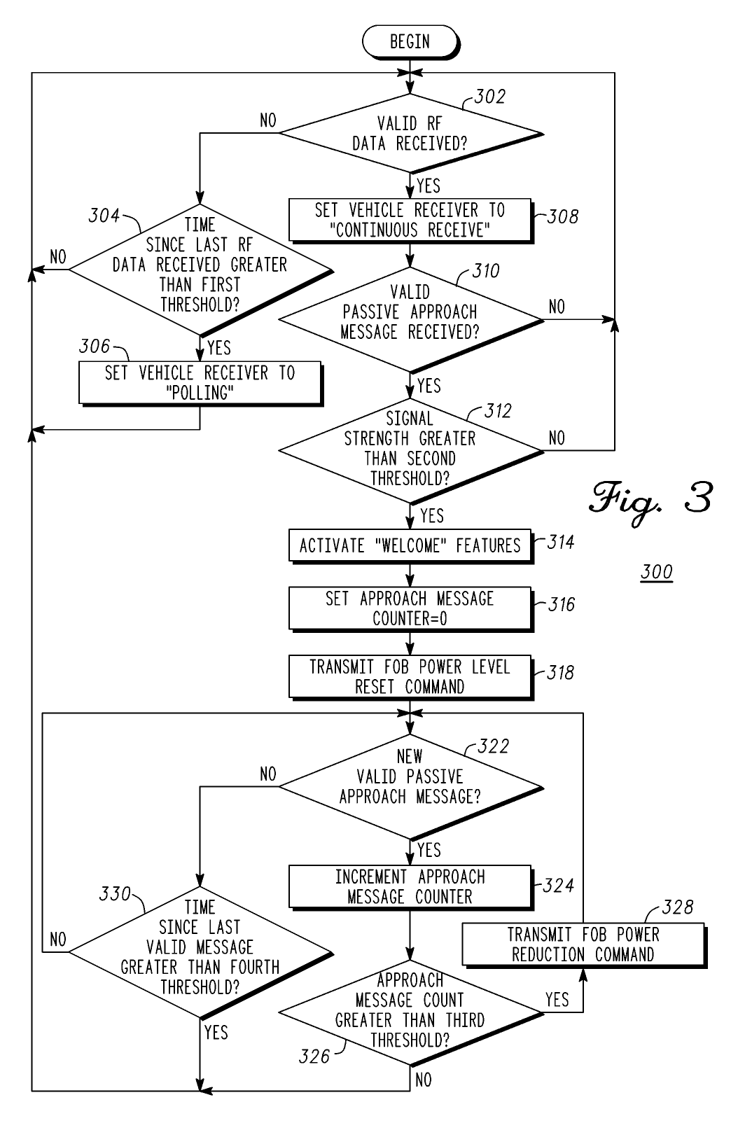

A key fob 202 shown in FIG. 2 includes a controller 204, a memory 206, a transceiver 108, and a user interface 110. The key fob 202 may be of any shape and may have a door and/or an ignition key integrated therewith. The controller 204 preferably is a microprocessor, but may be other types of circuitry such as application specific integrated circuits or discrete logic. The memory 206 preferably is ROM and may be or not be combined with the controller 204. The transceiver 208, and an antenna 212 coupled thereto, are capable of transmitting and receiving in any one of numerous RF ranges. The RF range of 900 MHz to 920 MHz is preferred for the exemplary embodiment. The optional user interface 210 may simply be an on/off switch, or may also include a switch for activating the approach features on the vehicle, a display and menu structure, touch screens or other common interfaces. A battery 214, which may be rechargeable and/or of fixed capacity, is provided to supply power to each of the controller 204, memory 206, transceiver 208, and user interface 210.

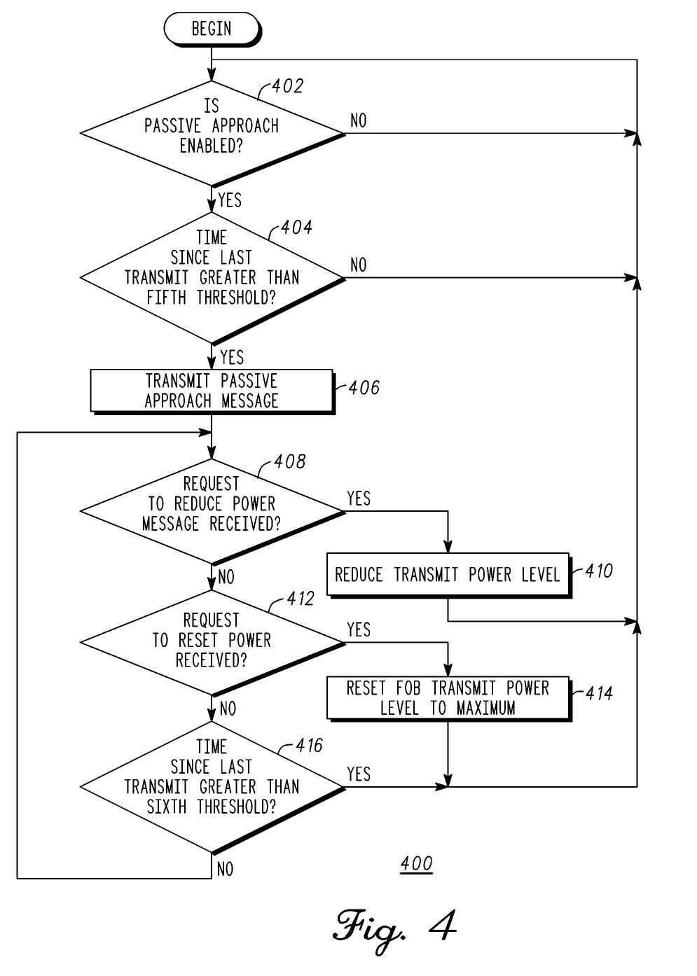

Referring to FIG. 3, the method 300 applied by the exemplary vehicle system 102 includes determining whether RF data is received 302. If not, and a time defined by a first threshold has not been surpassed 304, the vehicle system continues to search 302 for RF data. If the first threshold has been surpassed, the vehicle system is set 306 to a “polling” mode in which the search 302 for RF data is accomplished only periodically in order to save power. The first threshold may be in the range of 0.1 to 10.0 seconds, but preferably is about 1 second. If RF data is detected 302, the vehicle system is set 308 to a continuous receive mode (if previously in the polling mode), and if it is determined 310 the RF data does not indicate a passive approach, the search 302 for RF data is continued. If the RF data indicates 310 a valid passive approach but the RF data signal strength is low 312 (below a second threshold), the search 302 for RF data is continued. A “valid” passive approach message is a message which contains header information and a format that is specific to the periodic approach message and contains an identification which has been matched/programmed to the vehicle. The signal strength (second) threshold may be 127 for an 8 bit RSSI signal, for example. Signal strength is typically reported by most receivers as an A/D output level. The specific (second) threshold will ultimately depend on receiver sensitivity, antenna gain, and vehicle mounting location. It is desirable for the approach to be triggered within the more linear portion of the RSSI range; therefore, a mid-range threshold is desired. If the second threshold is surpassed 312, the welcome (approach) features of the vehicle are activated 314, a message counter is set to zero 316, and the key fob is instructed 318 to reset its power to its maximum power level. Resetting to the maximum power level upon detection of approach allows the system to operate fully on the next approach cycle if the key fob is removed from the area. If the key fob power is not reset at this time, the fob will continue to trigger the approach functions at a reduced range until some other trigger occurs. Alternatively, an event like opening the door can be used to trigger the reset.

Unintended activation of the welcome features is prevented by the following steps. If the received RF data is a valid message 322, the message counter is incremented 324 and if the message counter exceeds a third threshold 326, for example 10 counts, an instruction is sent 328 to the key fob to reduce its power. With an exemplary range of 200 meters, then periodic transmission from the fob is likely to be greater than 30 seconds. Utilizing 10 counts would require continued presence of at least 5 minutes. These steps 322, 324, 326, 328 are repeated until either the determination 322 that an approach message is not received 322 and a determined time period (fourth threshold) is surpassed 330 (wherein step 302 is commenced), or if the message counter does not exceed the third threshold, step 328 is bypassed. An example of the fourth threshold would be 65 seconds. This threshold would be set based upon the value of the fifth threshold. To allow for potential interference with any single transmission from the key fob, the value would preferably be set higher than twice the period on which the fob transmits.

Referring to FIG. 4, the method 400 applied by the exemplary key fob 202 includes determining that the passive approach capability is enabled 402 and if a predetermined amount of time (fifth threshold) has passed 404, then an approach message is transmitted 406. An example of the fifth threshold would be 30 seconds. If instructions are received 408 from the vehicle system 102 to reduce power, the key fob power is reduced 410 before returning to step 402. If such instructions have not been received, but instructions to reset power of the key fob 202 have been received 412, then the key fob power is set 414 to maximum. If a predetermined amount of time has passed 416 (sixth threshold), step 402 is initiated, if not, then step 408 is initiated. An example of the sixth threshold would be 250 milliseconds. The sixth threshold is based upon the transmit time of the message to the vehicle, plus the transmit time back from the vehicle, processing time, and a retry delay for the vehicle to perform two transmissions.

A method has been described for passively detecting a key fob approaching a vehicle and enabling welcome (approach) features or functions. The key fob power is minimized when not approaching the vehicle in order to increase battery life. An approach is detected even when the key fob has been in proximity with the vehicle for an extended period of time. The use of RF signals to trigger passive approach features accommodates greater range with lower power consumption

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for activating vehicle features when approaching a vehicle, comprising:
receiving a message by a vehicle system from a key fob;
determining if the key fob is approaching the vehicle;
activating selected vehicle features; and
instructing the key fob, if continued presence is detected, to reduce power until the message is no longer received by the vehicle system.

2. The method of claim 1 wherein the activating step comprises activating approach lighting.

3. The method of claim 1 wherein the receiving step comprises receiving the message by an automobile system.

4. The method of claim 1 wherein the receiving step comprises receiving an RF signal, and the instructing step comprises transmitting an RF signal.

5. The method of claim 1 wherein the determining step comprises determining the signal strength of the received message.

6. The method of claim 1 further comprising, prior to activating selected vehicle features, increasing a transmission power of the key fob.

7. The method of claim 1 further comprising setting a receiver in the vehicle to continuously receive the message.

8. The method of claim 1 wherein the instructing step further comprises reducing power in increments.

9. A method for activating vehicle features when approaching a vehicle, comprising:
periodically transmitting a message from a key fob to a vehicle;
setting the vehicle receiver to a continuous mode in response to the message;
determining if the key fob is approaching the vehicle;
activating selected vehicle features if the RF message signal strength surpasses a threshold; and
instructing the key fob to reduce power in predefined increments until no longer received if continued presence is detected.

10. The method of claim 9 wherein the activating step comprises activating approach lighting.

11. The method of claim 9 wherein the setting step comprises receiving the message by an automobile system.

12. The method of claim 9 wherein the setting step comprises receiving an RF signal, and the instructing step comprises transmitting an RF signal.

13. The method of claim 9 wherein the determining step comprises determining the signal strength of the received message.

14. The method of claim 9 further comprising, prior to activating selected vehicle features, increasing a transmission power of the key fob.

15. The method of claim 9 further comprising setting a receiver in the vehicle to continuously receive the message.

16. The method of claim 9 wherein the instructing step further comprises reducing power in increments.

17. A method for activating vehicle features when approaching a vehicle, comprising:
a) setting a vehicle system to a continuously receiving mode if receiving RF messages, otherwise one of:
b) setting the vehicle receiver to a reduced power mode and returning to step a) if not receiving RF messages and if the time since receiving the previous RF message exceeds a first threshold; and
c) returning to step a) if not receiving RF messages and if the time since receiving the previous RF message does not exceed a first threshold;
d) activating vehicle features if the RF message signal strength exceeds a second threshold, otherwise returning to step a);
e) incrementing a message counter if the RF message is valid;
f) instructing the fob to increase power;
g) incrementing the message counter if the RF message is new;
h) instructing the fob to reduce power if the number of RF messages received exceeds a third threshold and returning to step g), otherwise returning to step g); and
i) returning to step a) if the RF message is not new and the time since the previous new RF message exceeds a fourth threshold, otherwise returning to step g).

18. The method of claim 17 wherein the activating step comprises activating approach lighting.

19. The method of claim 17 wherein the setting a vehicle system comprises receiving the RF messages by an automobile system.

20. The method of claim 17 further comprising, prior to activating vehicle features, increasing a transmission power of the key fob.
